(19) United States
(12) Patent Application Publication
(10) Pub. No.: US 2008/0249713 A1
(43) Pub. Date: Oct. 9, 2008

(54) GPS POSITION ACCURACY USING FEEDBACK FROM A MAP DATABASE

(76) Inventor: Darren Brett Sessions, Aliso Viejo, CA (US)

Correspondence Address: GATES & COOPER LLP;HOWARD HUGHES CENTER, 6701 CENTER DRIVE WEST, SUITE 1050, LOS ANGELES, CA, 90045, US

(21) Appl. No.: 11/835,947

(22) Filed: Aug. 8, 2007

Related U.S. Application Data
(60) Provisional application No. 60/909,884, filed on Apr. 3, 2007.

(51) Int. Cl. G01C 21/32; G01C 21/20; G01S 1/00

(52) U.S. Cl. 701/211; 342/357.02; 701/214

(57) ABSTRACT

A mapping software feedback correction system for use with GPS receivers and GPS enabled devices. A Global Positioning System (GPS) receiver in accordance with the present invention comprises a Radio Frequency (RF) section, the RF section adaptable to receive at least one GPS signal from at least one GPS satellite; and a baseband section, coupled to the RF section, wherein the baseband section performs calculations to determine a geoposition of the GPS receiver based on the at least one GPS signal, wherein the geoposition is determined based on a mapping software correction factor.

### CROSS-REFERENCE TO RELATED APPLICATIONS

This application claims the benefit under 35 U.S.C. Section 119(e) of co-pending and commonly-assigned U.S. provisional patent application Ser. No. 60/909,884, filed Apr. 3, 2007, entitled “GPS POSITION ACCURACY USING FEEDBACK FROM A MAP DATABASE,” by Darren Brett Sessions, which application is incorporated by reference herein.

### BACKGROUND OF THE INVENTION

1. Field of the Invention

The present invention relates generally to Global Positioning System (GPS) receivers, and in particular, to improving GPS position accuracy using feedback from a map database.

2. Description of the Related Art

The use of GPS in consumer products has become commonplace. Hand-held devices used for mountaineering, automobile navigation systems, and GPS for use with cellular telephones are just a few examples of consumer products using GPS technology.

GPS-enabled devices, such as cellular telephones, have also been introduced into the consumer marketplace. These devices allow for the use of Location-Based Services (LBS) which are services, advertisements, and other features that are offered based on the location of the user. As such, GPS-enabled devices are used worldwide.

A specific use of GPS receivers is in the navigation systems of automobiles. The navigation system is a useful feature to assist drivers in finding specific locations, as well as local businesses and directions from place to place.

However, many places that automobiles travel do not always have reasonable GPS satellite views. Tunnels, downtown areas, and dense overgrowth all contribute to signal strength losses and increase the error in determining geolocation for an automobile.

It can be seen, then, that there is a need in the art to make GPS-enabled devices operable in environments where GPS satellites are not directly visible.

### SUMMARY OF THE INVENTION

To minimize the limitations in the prior art, and to minimize other limitations that will become apparent upon reading and understanding the present specification, the present invention describes a mapping software feedback correction system for use with GPS receivers and GPS enabled devices. A Global Positioning System (GPS) receiver in accordance with the present invention comprises a Radio Frequency (RF) section, the RF section adaptable to receive at least one GPS signal from at least one GPS satellite; and a baseband section, coupled to the RF section, wherein the baseband section performs calculations to determine a geoposition of the GPS receiver based on the at least one GPS signal, wherein the geoposition is determined based on a mapping software correction factor.

Such a GPS receiver further optionally includes the mapping software correction factor being based on a difference between a first geoposition determined by the GPS receiver and a snap-to-road position determined by the mapping software, the mapping software correction factor being used in a feedback loop, the mapping software correction factor being used in a navigation algorithm of the GPS receiver, the GPS receiver calculating a new geoposition based on at least one new signal from at least one GPS satellite and the mapping software correction factor, the GPS receiver being used in an automotive navigation system, and the mapping software correction factor further comprising a quality factor.

A method for determining a position of a receiver using Global Positioning System (GPS) signals in accordance with the present invention comprises determining the position of at least a first GPS receiver using GPS signals, providing a correction factor to the position from a mapping software algorithm, seeding a navigation algorithm of the at least first GPS receiver with the correction factor, and calculating a new position of the at least first GPS receiver using the correction factor.

Such a method further optionally includes the correction factor being used in a feedback loop, the GPS receiver calculating a new geoposition based on at least one new signal from at least one GPS satellite and the correction factor, and the correction factor further comprising a quality factor.

A navigation system in accordance with the present invention comprises a Global Positioning System (GPS) receiver, a processor, coupled to the GPS receiver, a database, coupled to the processor, and a display, coupled to the processor, wherein the display illustrates the position of the object on a map derived from the database, the position of the object being determined by at least a calculated position determined by the GPS receiver and a correction factor comprising a difference between the calculated position and a determined position based on the map derived from the database.

Such a system further optionally comprises the correction factor comprising at least longitude and latitude data, the correction factor being used in a feedback loop, the correction factor being used in a navigation algorithm of the GPS receiver, the GPS receiver calculating a new geoposition based on at least one new signal from at least one GPS satellite and the correction factor, the GPS receiver being used in an automotive navigation system, the correction factor further comprising a quality factor.

### BRIEF DESCRIPTION OF THE DRAWINGS

Referring now to the drawings in which like reference numbers represent corresponding parts throughout:

FIG. 1 illustrates a typical Satellite Positioning System in accordance with the present invention;

FIG. 2 illustrates a navigation system in accordance with the present invention;

FIG. 3 illustrates the possible locations of vehicles on a map, which is used in accordance with the present invention; and

FIG. 4 illustrates a feedback schema in accordance with the present invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

### Overview

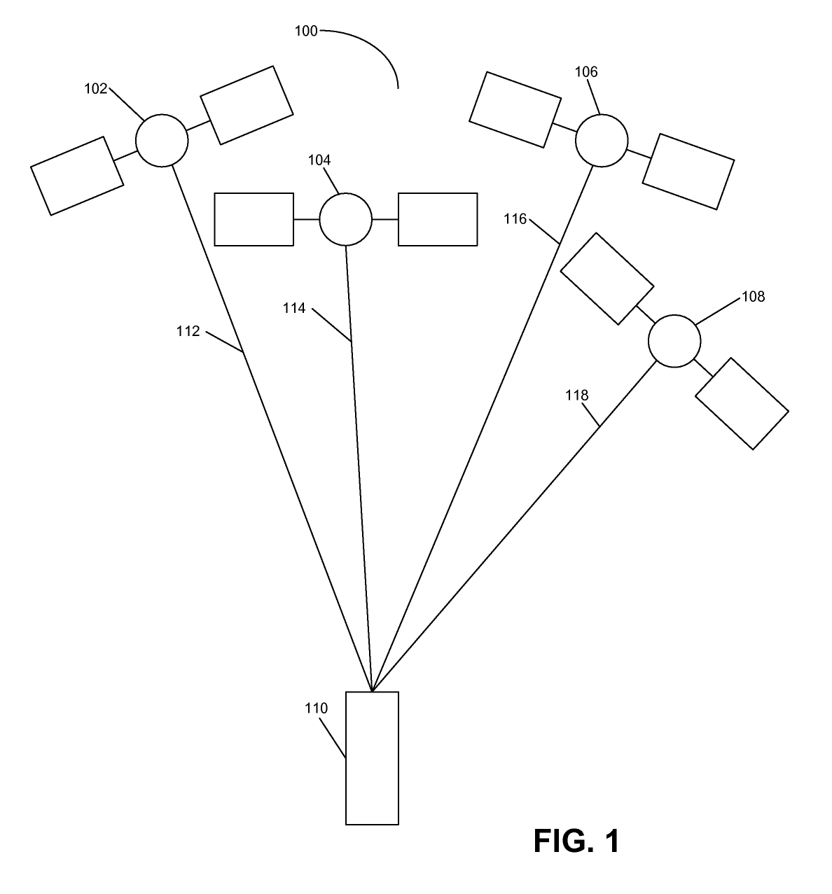

FIG. 1 illustrates a typical Satellite Positioning System in accordance with the present invention.

System 100 illustrates a constellation of satellites 102-108 and a receiver 110. Each of the satellites 102-108 transmits a signal 112-118 respectively, which signals 112-118 are received by receiver 110.

Signals 112-118 contain information such as time of transmission and system time for system 100. Receiver 110 uses the time it takes for signals 112-118 to travel the distances between the satellites 102-108 and receiver 110 and the data within signals 112-118 to determine the x, y, and z coordinates (geoposition) of receiver 110. This generic ranging system is typically known as the Global Positioning System (GPS), which is described in the related art.

The frequencies of interest in a GPS system 100 are in the “L-band” of frequencies, typically around 1575 MHz, but other positioning systems with other frequencies of interest can also benefit from the present invention.

### Positional Accuracy Issues

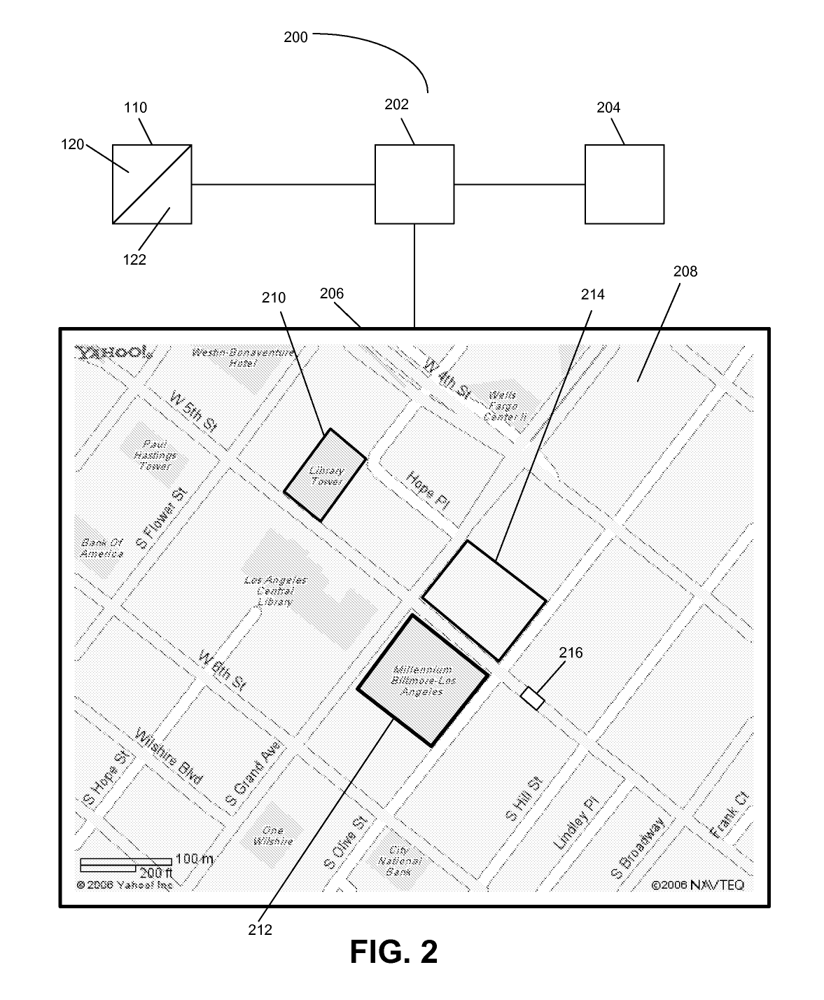

FIG. 2 illustrates a navigation system in accordance with the present invention.

As shown in FIG. 1, when there is a clear view of four or more GPS satellites 102-108, signals 112-118 are easily received by a GPS receiver 110 and a relatively accurate position of receiver 110 can be readily calculated. However, there are many areas that GPS location is needed that have obscured views of the sky. Downtown areas in large urban cities, for example, have high-rise buildings that block large sections of the sky, and any satellite 102-108 that is in that section of the sky is not visible to the GPS receiver 110. Such situations where portions of the sky are blocked are called “urban canyons.”

When a GPS receiver 110 is being used in a navigation system, e.g., in an automobile, the system typically uses the GPS position and plots the position on a map that is visible in a car.

### Navigation System

FIG. 2 shows system 200, with GPS receiver 110, processor 202, map database 204, and display 206. Map 208 is displayed on display 206, where map 208 is selected from map database 204 and processed such that map 208 is legible on display 206.

Within GPS receiver 110, a Radio Frequency (RF) section 120 is adaptable to receive at least one GPS signal from at least one GPS satellite, and a baseband section 122 is coupled to the RF section 120. RF section downconverts the received signals 112-118, and baseband section 122 uses the downconverted signals to perform calculations to determine a geoposition of the GPS receiver based on the at least one GPS signal 112-118 which is received from RF section 120.

Buildings 210, 212, and 214 are located on map 208. Building 210 is a seventy-three story building, building 212 is a twenty-four story building, and building 214 is a fifty-two story building. When vehicle 216 is travelling on West 5^{th} Street, as shown on map 208 in FIG. 2, the northwestern sky is completely blocked by buildings 210-212, and any signals coming from GPS satellites 102-108 that are in the southeastern sky may have multipath issues because of buildings 212 and 214. As such, it will be difficult to determine exactly where vehicle 216 is located.

The multipath effect delivers one or more of the signals 112-118 to the GPS receiver 110 after reflecting from a building surface as well as directly to the GPS receiver 110, which creates additional errors in the final position calculation.

Navigation systems, e.g., systems resident in processor 202, use a map database 204 to take the raw GPS position output from receiver 110 and employ a “snap to road” algorithm in an attempt to keep the vehicle 216 on the street. For example, in FIG. 2, vehicle 216 is shown as on West 5^{th} Street, rather than in the middle of a block which the GPS receiver 110 in vehicle 216 indicates as the position of vehicle 216.

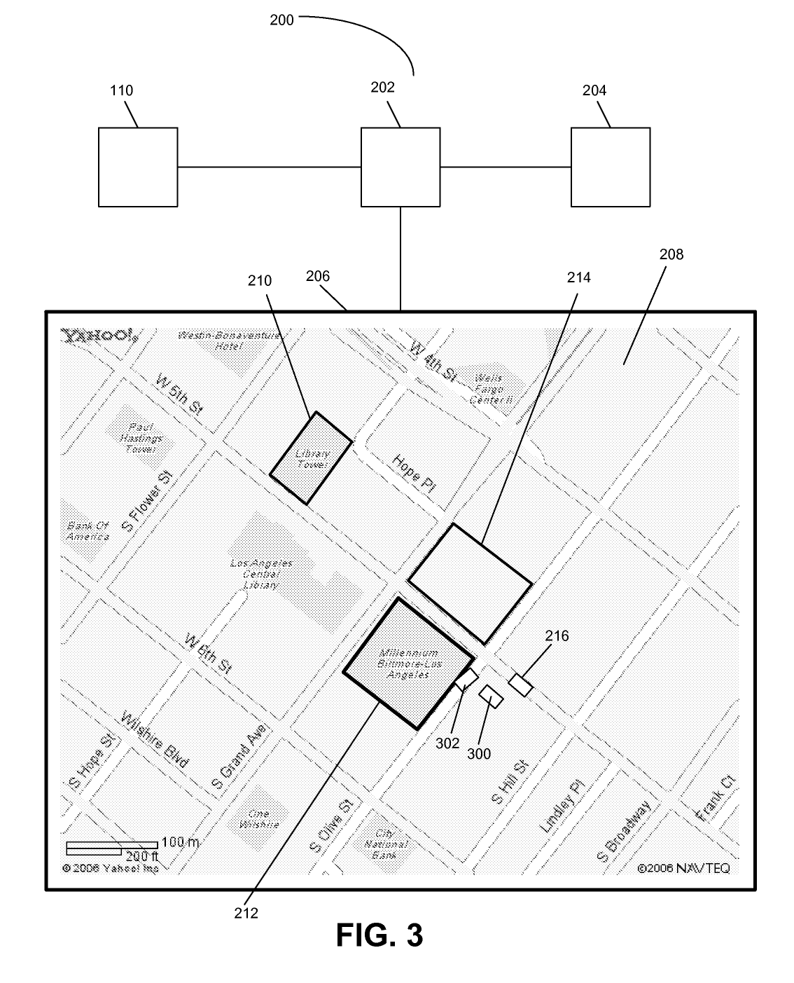

FIG. 3 illustrates the possible locations of vehicles on a map, which is used in accordance with the present invention.

Position 300 illustrates the “calculated position” of a given vehicle with a GPS receiver 110. However, since the vehicle is typically a car, it cannot be “off the road” and in the middle of a building, so the processor 202, using the map database 204, makes decisions to place the vehicle either at position 216 or position 302, depending on the software and algorithms used to determine position of the vehicle.

The differences between the calculated position 300 and the reported position (whether that reported position is position 216 or position 302) is a correction factor that is ignored in current systems. The present invention uses this difference, which may vary over time, to generate better positioning of the vehicle on the map 208. Since, as the vehicle travels northwest, the GPS errors in GPS receiver 110 will likely grow larger, the mapping software, in processor 202, may inadvertently make invalid corrections thereby placing the vehicle on the wrong street or going in the wrong direction.

As such, the present invention, in order to minimize the GPS errors in a harsh signal environment such as that shown in FIGS. 2 and 3, allows for software and hardware that provides the GPS receiver 110 the ability to take advantage of the map database information available to the mapping software in processor 202.

So, by determining the difference between the calculated position 300 (also called the “raw position output” of GPS receiver 110) and where the processor 202 has placed the vehicle on map 208 (for sake of discussion, that position is at position 216), the processor then uses the difference between position 300 and position 216 as a feedback term to the GPS receiver 110 for future calculations. The difference acts as an offset term for the position calculation done by GPS receiver 110.

### Feedback Operation

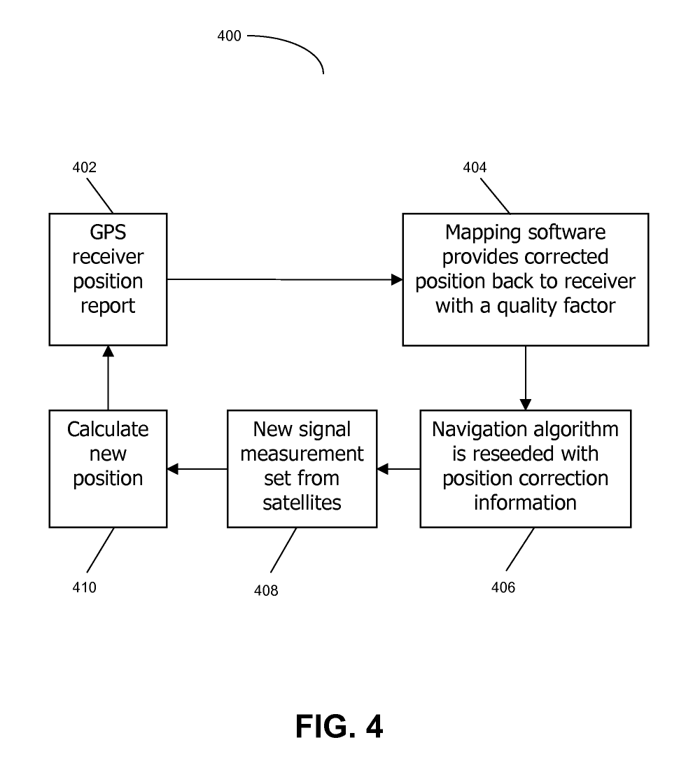

FIG. 4 illustrates a feedback schema in accordance with the present invention.

Loop 400 shows in block 402 the GPS receiver 110 generating a raw position report, and providing the raw position output to the mapping software. The mapping software then employs its snap to road algorithm to create a new position that is presented to the end user in block 404. This position correction is then fed back to the GPS receiver 110 in block 406 as a seed or re-seed for the navigation algorithm in the GPS receiver 110.

The position feedback provided by block 406 will typically include latitude and longitude, but may also include altitude, heading, speed, or any other information that may assist the GPS receiver 110. In addition, the mapping software may provide a quality factor that represents the degree of confidence associated with the corrected position. The correction information may also be presented to the receiver using a different coordinate system, for example, xyz instead of 11a.

The GPS receiver 110 will then reseed its navigation algorithm with the correction information in block 406, using the quality factor to determine how much gain or how much weighting should be applied to the corrected data. By reseeding the navigation algorithm with the corrected position data, the GPS receiver 110 will generate a more accurate reference position. This improved reference position will be combined with the new measurements received from the GPS satellites, resulting in improved position accuracy.

When the GPS receiver 110 receives a new signal measurement set in block 408, the re-seeded navigation algorithm is used to calculate the new position of the GPS receiver 110 in block 410. The position report is then generated from this new position and sent to the mapping software to determine a new correction factor in block 404.

Although described with respect to an automotive navigation system, the present invention can be used in any product that has access to a map database, such as PND's or Smart Phones, or any other product capable of making position corrections that can be fed back to the receiver. These other products will also benefit from improved position accuracy.

### CONCLUSION

In summary, the present invention describes a mapping software feedback correction system for use with GPS receivers and GPS enabled devices. A Global Positioning System (GPS) receiver in accordance with the present invention comprises a Radio Frequency (RF) section, the RF section adaptable to receive at least one GPS signal from at least one GPS satellite; and a baseband section, coupled to the RF section, wherein the baseband section performs calculations to determine a geoposition of the GPS receiver based on the at least one GPS signal, wherein the geoposition is determined based on a mapping software correction factor.

Such a GPS receiver further optionally includes the mapping software correction factor being based on a difference between a first geoposition determined by the GPS receiver and a snap-to-road position determined by the mapping software, the mapping software correction factor being used in a feedback loop, the mapping software correction factor being used in a navigation algorithm of the GPS receiver, the GPS receiver calculating a new geoposition based on at least one new signal from at least one GPS satellite and the mapping software correction factor, the GPS receiver being used in an automotive navigation system, and the mapping software correction factor further comprising a quality factor.

A method for determining a position of a receiver using Global Positioning System (GPS) signals in accordance with the present invention comprises determining the position of at least a first GPS receiver using GPS signals, providing a correction factor to the position from a mapping software algorithm, seeding a navigation algorithm of the at least first GPS receiver with the correction factor, and calculating a new position of the at least first GPS receiver using the correction factor.

Such a method further optionally includes the correction factor being used in a feedback loop, the GPS receiver calculating a new geoposition based on at least one new signal from at least one GPS satellite and the correction factor, and the correction factor further comprising a quality factor.

A navigation system in accordance with the present invention comprises a Global Positioning System (GPS) receiver, a processor, coupled to the GPS receiver, a database, coupled to the processor, and a display, coupled to the processor, wherein the display illustrates the position of the object on a map derived from the database, the position of the object being determined by at least a calculated position determined by the GPS receiver and a correction factor comprising a difference between the calculated position and a determined position based on the map derived from the database.

Such a system further optionally comprises the correction factor comprising at least longitude and latitude data, the correction factor being used in a feedback loop, the correction factor being used in a navigation algorithm of the GPS receiver, the GPS receiver calculating a new geoposition based on at least one new signal from at least one GPS satellite and the correction factor, the GPS receiver being used in an automotive navigation system, the correction factor further comprising a quality factor.

The preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but by the claims and the equivalents of the claims which form a part of this application.

What is claimed is:

1. A Global Positioning System (GPS) receiver, comprising:
a Radio Frequency (RF) section, the RF section adaptable to receive at least one GPS signal from at least one GPS satellite; and
a baseband section, coupled to the RF section, wherein the baseband section performs calculations to determine a geoposition of the GPS receiver based on the at least one GPS signal, wherein the geoposition is determined based on a mapping software correction factor.

2. The GPS receiver of claim 1, wherein the mapping software correction factor is based on a difference between a first geoposition determined by the GPS receiver and a snap-to-road position determined by the mapping software.

3. The GPS receiver of claim 2, wherein the mapping software correction factor is used in a feedback loop.

4. The GPS receiver of claim 3, wherein the mapping software correction factor is used in a navigation algorithm of the GPS receiver.

5. The GPS receiver of claim 4, wherein the GPS receiver calculates a new geoposition based on at least one new signal from at least one GPS satellite and the mapping software correction factor.

6. The GPS receiver of claim 5, wherein the GPS receiver is used in an automotive navigation system.

7. The GPS receiver of claim 6, wherein the mapping software correction factor further comprises a quality factor.

8. A method for determining a position of a receiver using Global Positioning System (GPS) signals, comprising:
determining the position of at least a first GPS receiver using GPS signals;
providing a correction factor to the position from a mapping software algorithm;
seeding a navigation algorithm of the at least first GPS receiver with the correction factor; and
calculating a new position of the at least first GPS receiver using the correction factor.

9. The method of claim 8, wherein the correction factor is used in a feedback loop.

10. The method of claim 9, wherein the GPS receiver calculates a new geoposition based on at least one new signal from at least one GPS satellite and the correction factor.

11. The method of claim 10, wherein the correction factor further comprises a quality factor.

12. A navigation system for determining a position of an object, comprising:
a Global Positioning System (GPS) receiver;
a processor, coupled to the GPS receiver;
a database, coupled to the processor; and
a display, coupled to the processor, wherein the display illustrates the position of the object on a map derived from the database, the position of the object being determined by at least a calculated position determined by the GPS receiver and a correction factor comprising a difference between the calculated position and a determined position based on the map derived from the database.

13. The navigation system of claim 12, wherein the correction factor comprises at least longitude and latitude data.

14. The navigation system of claim 13, wherein the correction factor is used in a feedback loop.

15. The navigation system of claim 14, wherein the correction factor is used in a navigation algorithm of the GPS receiver.

16. The navigation system of claim 15, wherein the GPS receiver calculates a new geoposition based on at least one new signal from at least one GPS satellite and the correction factor.

17. The navigation system of claim 16, wherein the GPS receiver is used in an automotive navigation system.

18. The navigation system of claim 17, wherein the correction factor further comprises a quality factor.
